(19) United States
(12) Patent Application Publication
(10) Pub. No.: US 2010/0288083 A1
(43) Pub. Date: Nov. 18, 2010

(54) MODULAR WRENCH

(76) Inventors: Min-Chun YU, Yuanlin Chen (TW); Shun-Hang HUANG, Huatan Hsiang (TW)

Correspondence Address: PATENTTM.US, P. O. BOX 82788, PORTLAND, OR, 97282-0788, US

(21) Appl. No.: 12/464,296

(22) Filed: May 12, 2009

(51) Int. Cl. B25B 13/06; B25B 13/00

(52) U.S. Cl. 81/121.1; 81/185.2

(57) ABSTRACT

A modular wrench has a shaft, a connecting protrusion and a socket mount. The shaft has two ends and two sides. The connecting protrusion is formed on and protrudes from one side at one of the ends. The socket mount is attached to the other end of the shaft, may be mounted in or formed on the same or opposite side and has a mounting hole formed in the socket mount. The socket mount can be combined with the connecting protrusion of another modular wrench to extend length or adjust configuration of the modular wrench. A socket is mounted in a distal socket mount corresponding to and for tightening or loosening fasteners. Therefore, the modular wrench can be easily adapted to work fasteners of machines.

### BACKGROUND OF THE INVENTION

1. Field of the Invention

The present invention relates to a hand tool, and more particularly to a modular wrench with adjustable length and configuration.

2. Description of Related Art

A conventional T-wrench or L-wrench is connected to a sleeve to tighten or release a bolt on a vehicle or a precise machine.

However, the conventional T-wrench or L-wrench has a length that cannot be adjusted, so the conventional wrench can only be applied to fasteners with sufficient space axially extending from the fastener. Therefore, fasteners located in awkward places, such as far away from an access point or opening, cannot be adjusted without disassembly or removal of such part, for instance, a bolt on a bottom of an engine block or the like. Such disassembly or removal may cause damage or require arduous reassembly.

To overcome the shortcomings, the present invention tends to provide a modular wrench for a wrench to mitigate or obviate the aforementioned problems.

### SUMMARY OF THE INVENTION

A modular wrench has a shaft, a connecting protrusion and a socket mount. The shaft has two ends and two sides. The connecting protrusion is formed on and protrudes from one side at one of the ends. The socket mount is attached to the other end of the shaft, may be mounted in or formed on the same or opposite side and has a mounting hole formed in the socket mount. The socket mount can be combined with the connecting protrusion of another modular wrench to extend length or adjust configuration of the modular wrench. A socket is mounted in a distal socket mount corresponding to and for tightening or loosening fasteners. Therefore, the modular wrench can be easily adapted to work fasteners of machines.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a modular wrench in accordance with the present invention;

FIG. 2 is a top view of the modular wrench in FIG. 1;

FIG. 3 is an operational perspective view of the modular wrench in FIG. 1;

FIG. 4 is a perspective view of a second embodiment of a modular wrench in accordance with the present invention;

FIG. 5 is a perspective view of a third embodiment of a modular wrench in accordance with the present invention combined with the modular wrench in FIG. 1; and

FIG. 6 is an enlarged exploded perspective view of a fourth embodiment of the modular wrench in accordance with the present invention.

### DETAILED DESCRIPTION OF PREFERRED EMBODIMENT

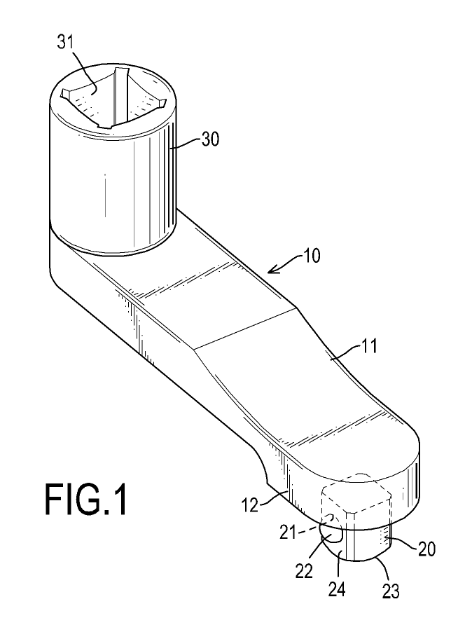

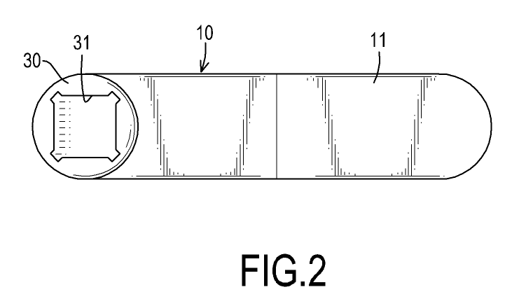

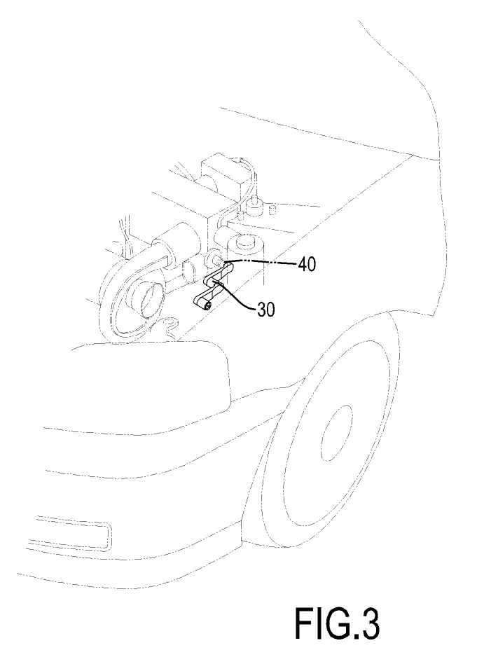

With reference to FIGS. 1, 2 and 3, a modular wrench in accordance with the present invention comprises a shaft (10), a connecting protrusion (20), a socket mount (30) and an optional socket (40).

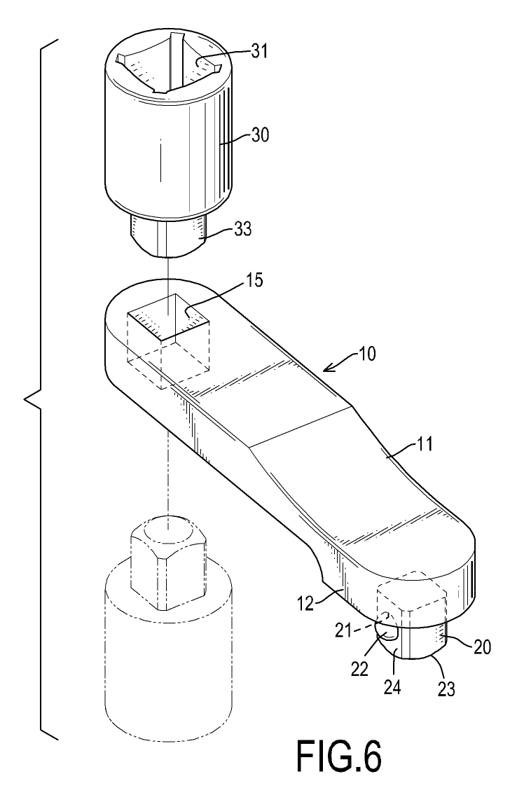

With further reference to FIG. 6, the shaft (10) may be a bar and has two ends, two sides, an optional cambered surface (11), an optional protrudent surface (12) and a through hole (15). The cambered surface (11) is formed on one side of the shaft (10) at one of the ends and is concave. The protrudent surface (12) is defined on an opposite surface to the cambered surface (11) at the same end as the cambered surface (11). The through hole (15) may be square and is defined at the end of the shaft (10) opposite to the cambered surface (11).

The connecting protrusion (20) is square, may be polygonal, is formed on and protrudes perpendicularly from one side at one end of the shaft (10), and may be formed on the protrudent surface (12). The connecting protrusion (20) has four side walls (24), at least one hole (21) and at least one positioning element (22) and a distal end (23). Four side walls (24) may be implemented. The at least one hole (21) is formed in a corresponding side wall (24) of the connecting protrusion (20) and two holes (21) may be formed in opposite side walls (24). The at least one positioning element (22) is mounted in and partially protrudes selectively from a corresponding hole (21). The distal end (23) of the connecting protrusion (20) may be convex.

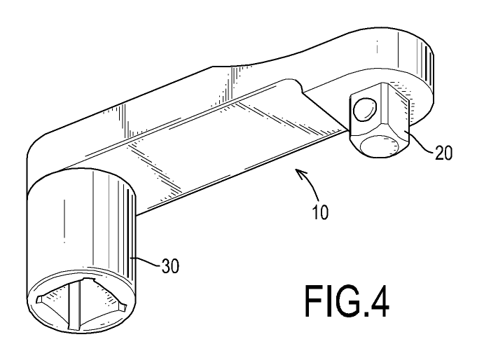

With further reference to FIG. 4, the socket mount (30) is attached to the shaft (10) opposite to the connecting protrusion (20), may be formed on or mounted in the through hole (15) on the opposite side, or on the same side of the shaft (10) and may be a cylinder. The socket mount (30) has a mounting hole (31) and a combined protrusion (33). The mounting hole (31) corresponds to the connecting protrusion (20) and is polygonal in cross section, may be triangular, square, hexagonal, octagonal or the like and may correspond to a bolt head, nut or the like, is formed centrally in the socket mount (30) and has multiple mounting walls, multiple corners and at least one optional detent. The corners are formed between two adjacent mounting walls and may be beveled or recessed to aid and guide the connecting protrusion (20) into the mounting hole (31). The at least one detent corresponds to the at least one positioning element (22) and may be an annular recess formed in the mounting walls or may be multiple concavities formed in corresponding mounting walls. The combined protrusion (33) is opposite to the mounting hole (31), may have a structure the same as that of the connecting protrusion (20) and is mounted detachably in the through hole (15). Since the combined protrusion (33) can be mounted on the same side or the opposite side to the connecting protrusion (20), one modular wrench can be applied in different environments.

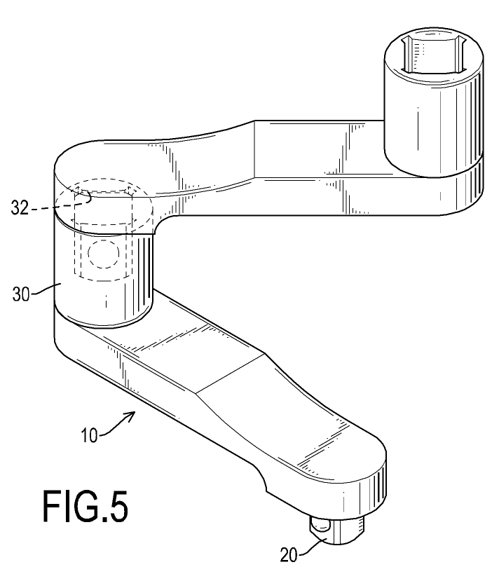

With further reference to FIG. 5, the socket mount (30) has a mounting hole(32) that has a diagonal line having an angle of 45° relative to that of the connecting protrusion (20). The modular wrench can be assembled in various configurations, such as multiple shafts (10) linearly aligned, stepped, zigzagged, as a T, L, V or combination thereof. Further, the modular wrench may be combined with another wrench or socket (40).

Therefore, multiple modular wrenches can be easily combined to extend length of the modular wrench. Further, configuration of the modular wrench can be changed to access awkward areas, such as a car engine. Also, the cambered surface (11) allows the modular wrench to easily enter narrow spaces. Since the modular wrench can be disassembled, it is easy to carry, and cheaply and easily adapted and added-to for application in different jobs.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A modular wrench comprising:
a shaft having two ends and two sides;
a connecting protrusion being polygonal, being mounted formed on and protruding from one side at one of ends of the shaft; and
a socket mount being attached to and protruding from one side at the other end of the shaft, and having a mounting hole formed in the socket mount and corresponding to the connecting protrusion.

2. The modular wrench as claimed in claim 1, wherein the connecting protrusion further comprises:
multiple side walls;
at least one hole being formed in a corresponding side wall; and
at least one positioning element being mounted in and partially protruding selectively from a corresponding hole.

3. The modular wrench as claimed in claim 2, wherein the connecting protrusion is square.

4. The modular wrench as claimed in claim 3, wherein the shaft further comprises a cambered surface being formed on one side of the shaft at the end of the shaft opposite to the socket mount and being concave, wherein the connecting protrusion is formed on the opposite side of the shaft to the cambered surface.

5. The modular wrench as claimed in claim 4, wherein the shaft further comprises a protrudent surface being defined in the opposite side of the shaft to the cambered surface, wherein the connecting protrusion is formed on and protrudes from the protrudent surface.

6. The modular wrench as claimed in claim 5, wherein the shaft is a bar.

7. The modular wrench as claimed in claim 1, wherein the socket mount is formed on the opposite side of the shaft to the connecting protrusion.

8. The modular wrench as claimed in claim 2, wherein the socket mount is formed on the opposite side of the shaft to the connecting protrusion.

9. The modular wrench as claimed in claim 3, wherein the socket mount is formed on the opposite side of the shaft to the connecting protrusion.

10. The modular wrench as claimed in claim 4, wherein the socket mount is formed on the opposite side of the shaft to the connecting protrusion.

11. The modular wrench as claimed in claim 5, wherein the socket mount is formed on the opposite side of the shaft to the connecting protrusion.

12. The modular wrench as claimed in claim 6, wherein the socket mount is formed on the opposite side of the shaft to the connecting protrusion.

13. The modular wrench as claimed in claim 1, wherein the socket mount is formed on the same side of the shaft as the connecting protrusion.

14. The modular wrench as claimed in claim 2, wherein the socket mount is formed on the same side of the shaft as the connecting protrusion.

15. The modular wrench as claimed in claim 3, wherein the socket mount is formed on the same side of the shaft as the connecting protrusion.

16. The modular wrench as claimed in claim 4, wherein the socket mount is formed on the same side of the shaft as the connecting protrusion.

17. The modular wrench as claimed in claim 5, wherein the socket mount is formed on the same side of the shaft as the connecting protrusion.

18. The modular wrench as claimed in claim 6, wherein the socket mount is formed on the same side of the shaft as the connecting protrusion.

19. The modular wrench as claimed in claim 1, wherein the socket mount is mounted detachably on the shaft.

20. The modular wrench as claimed in claim 19, wherein the shaft further comprises a through hole being defined at the end of the shaft opposite to the cambered surface; and the socket mount comprising a combined protrusion being opposite to the mounting hole and being mounted detachably in the through hole.
